(19) United States
(12) Patent Application Publication
(10) Pub. No.: US 2015/0042158 A1
(43) Pub. Date: Feb. 12, 2015

(54) Battery System, Motor Vehicle Comprising said Battery System, and Method for Producing a Ready Status for a Motor Vehicle Comprising said Battery System

(71) Applicants: Ralph Schmidt, Weinstadt (DE); Joachim Fetzer, Bad-Ditzenbach (DE); Ralf Angerbauer, Moeglingen (DE); Stefan Butzmann, Beilstein (DE); Holger Fink, Stuttgart (DE)

(72) Inventors: Ralph Schmidt, Weinstadt (DE); Joachim Fetzer, Bad-Ditzenbach (DE); Ralf Angerbauer, Moeglingen (DE); Stefan Butzmann, Beilstein (DE); Holger Fink, Stuttgart (DE)

(73) Assignees: Robert Bosch BmbH, Stuttgart (DE); Samsung SDI Co., Ltd., Yongin-si, Gyeonggi-do (KR)

(21) Appl. No.: 14/123,603

(22) PCT Filed: May 31, 2012
(86) PCT No.: PCT/EP2012/060226

§ 371 Date: May 9, 2014

(30) Foreign Application Priority Data
Jun. 6, 2011 (DE) 10 2011 076 981.1

(51) Int. Cl. B60L 11/18; H01M 10/625; H01M 10/0525; H01M 2/10

(52) U.S. Cl. CPC B60L 11/1877; H01M 2/1077; H01M 10/5016; H01M 10/0525; H01M 2220/20
USPC 307/10.1; 429/96; 429/99; 429/72

(57) ABSTRACT

A battery system comprises at least one battery module and a docking station on which the at least one battery module is arranged in a separately removable manner. Preferably, the docking station comprises supply and/or power connections for the battery system.

The present invention relates to a battery system comprising a plurality of subunits, and to a motor vehicle comprising said battery system, and also to a method for producing a ready status for a motor vehicle comprising said battery system.

### PRIOR ART

It is known to construct battery systems from a plurality of subunits. In this case, an individual subunit is formed at least from an individual storage cell. An individual subunit can also have a plurality of storage cells which are combined to form a battery module, or a plurality of battery modules of this kind which are combined to form a battery pack. Accordingly, a battery system comprises at least two storage cells which are connected to one another.

It is likewise known to use a battery system as part of a drive system of a motor vehicle. Essentially two concepts are known for supplying the battery system with energy from a vehicle-external source in this case. In a first concept, the battery system is fixedly installed in the motor vehicle and remains in the motor vehicle during a charging process. The motor vehicle is then not available for use for the duration of the charging time. In a second concept, the battery system is designed such that all of the storage cells are combined in a single battery pack which is arranged such that it can be removed from the motor vehicle. By replacing the discharged battery pack with a physically identical charged battery pack, the motor vehicle is again ready for use within a short period of time, but a battery pack of this kind has a considerable volume and weight. In addition, the high voltage of the battery pack poses risks in the event of replacement.

### DISCLOSURE OF THE INVENTION

The invention provides a battery system which comprises at least one battery module comprising at least one storage cell and one docking station on which the at least one battery module is arranged such that it can be removed separately. The storage cells are preferably lithium ion cells in this case.

The battery modules therefore form subunits of the battery system which can be removed individually. This arrangement of battery modules advantageously allows individual battery modules of the battery system to be removed separately or the battery system according to the invention to be operated with a variable number of battery modules.

Handling the individual battery modules separately makes it easier to replace discharged or defective storage cells since not all of the storage cells are arranged in a single unit. Therefore, only a lower volume and a lower weight advantageously have to be taken into consideration in the event of replacement. In addition, the individual battery modules each have a lower voltage than the entire system. As a result, electrical accidents are advantageously prevented. In a preferred refinement of the battery system according to the invention, provision is therefore made for the individual battery modules to have a rated voltage of less than 60 volts.

Since not all of the storage cells are arranged in a single battery module, a defect in a storage cell does not necessarily lead to the need to replace all of the storage cells.

In a preferred refinement of the battery system according to the invention, it is provided that the docking station has electrical conductors and the battery modules which are arranged on the docking station are electrically connected to one another by means of the docking station.

Additional arrangements for electrically interconnecting the battery modules can advantageously be dispensed with as a result. To this end, the docking station preferably has corresponding conductor tracks and switching devices.

In a further preferred refinement of the battery system according to the invention, it is provided that the battery modules have identical constructions.

As a result, it is advantageously possible to install any battery module in any area of the docking region of the docking station. This advantageously provides a modular system in which the number of identical parts is increased and the number of different parts is reduced.

In a further preferred refinement of the battery system according to the invention, it is provided that the docking station has at least two docking locations and the battery modules each can be arranged or are arranged at a docking location, and the docking location has supply connections and/or power connections, and the supply connections and/or power connections can be operatively connected or are operatively connected to module-end supply and/or power connections of the battery modules.

This advantageously enables total connection of the battery modules to the docking stations, without having to use additional connecting systems. In addition, additional working steps can be dispensed with when fitting and/or removing the battery modules.

In a further preferred refinement of the battery system according to the invention, it is provided that the battery modules each have a cooling plate and module coolant connections as supply connections, and the docking locations of the docking station each have matching coolant connections for said module coolant connections.

As a result, it is advantageously possible to control the temperature of the individual battery modules, and additional temperature-control devices can be dispensed with. In addition, additional working steps can be dispensed with when fitting and/or removing the battery modules.

In a further preferred refinement of the battery system according to the invention, it is provided that the battery modules each have at least one module degassing connection as the supply connection, and the docking locations of the docking station each have at least one matching degassing connection for said module degassing connection.

As a result, it is advantageously possible to divert away the outgassings from the individual battery modules, and additional degassing devices can be dispensed with. In addition, additional working steps can be dispensed with when fitting and/or removing the battery modules.

In a further preferred refinement of the battery system according to the invention, it is provided that the battery modules each have at least one module control connection as the supply connection, and the docking locations of the docking station each have at least one matching control connection for said module control connection.

As a result, it is advantageously possible to control and monitor the individual battery modules. In addition, additional working steps can be dispensed with when fitting and/or removing the battery modules. As an alternative, the monitoring and/or control by radio are/is also envisaged.

In a further preferred refinement of the battery system according to the invention, it is provided that the battery modules have connecting elements for arranging further battery modules.

This advantageously provides the option of simple arrangement of further battery modules and/or adjacent battery modules can additionally be fixed by means of the connecting elements.

In a further preferred refinement of the battery system according to the invention, it is provided that the docking station comprises fixing means for reversibly fixing the battery modules.

As a result, it is advantageously possible to fit and/or to remove the battery modules without using a tool. This makes it easier to replace the battery modules.

Plug connections, latching devices, click-connection apparatuses, clamping apparatuses, bracing apparatuses or rail systems are preferably provided for this purpose.

The invention further provides a motor vehicle comprising the battery according to the invention in the abovementioned refinements, wherein the battery is connected to a drive system of the motor vehicle.

The advantages of the battery system according to the invention as a component therefore also benefit the motor vehicle as an assembly. The motor vehicle can additionally be operated with a set of battery modules, whereas a further set of battery modules can be charged in a stationary state. Therefore, relatively long out-of-service times of the motor vehicle can advantageously be avoided.

In a preferred refinement of the motor vehicle according to the invention, it is provided that the motor vehicle can be operated with a minimum number of battery modules and the minimum number is smaller than a maximum number of battery modules which can be connected to the docking station at the same time.

As a result, it is advantageously possible for the docking station to be designed for more battery modules than provided for ex-works. The power and the range of the motor vehicle can be increased as required by subsequently buying or renting further battery modules. In this way, the motor vehicle can advantageously be acquired at a favorable basic price.

The invention further provides a method for producing a ready status for a motor vehicle comprising a battery system in the abovementioned refinements. In this case, discharged or defective battery modules are individually removed from the docking station and replaced.

Advantageous developments of the invention are specified in the dependent claims and explained in the description.

In this application, the term “battery system” also includes batteries, accumulators, accumulator batteries, accumulator systems, in particular lithium ion systems or lithium polymer ion systems.

### DRAWINGS

The present invention is explained in greater detail with reference to the drawings and the following description. In the drawings:

FIG. 1 shows the schematic basic structure of a battery system according to the invention, and

FIG. 2 shows a view of a detail of a battery module of the battery system according to the invention.

### EMBODIMENTS OF THE INVENTION

A battery system which has an energy storage cell as the smallest subunit is described in the text which follows. In this case, a plurality of storage cells which are arranged in one direction are structurally combined to form battery modules. A plurality of battery modules can in turn be structurally combined to form a battery pack.

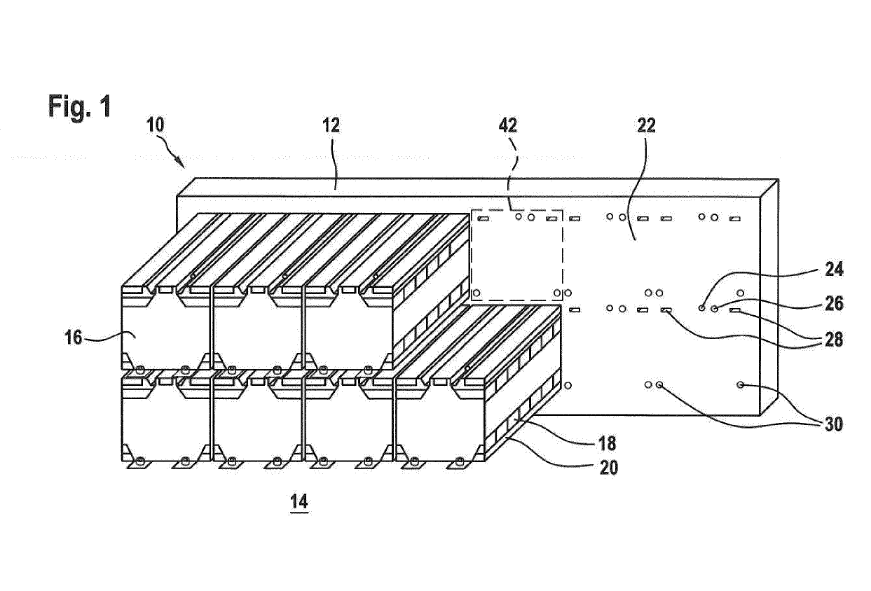

FIG. 1 shows, by way of example and in a non-limiting manner, the schematic basic structure of a battery system 10 according to the invention. The battery system 10 has at least one docking station 12 comprising a docking region 22. According to the invention, the docking region has at least two docking locations 42 for receiving individual battery modules 14. The design shown by way of example in FIG. 1 has twelve docking locations 42, five of which are unoccupied. Battery modules 16 are connected to seven of the docking locations 42.

In this invention, a battery module 16 constitutes an inherently replaceable unit. In this case, all of the battery modules 16 of the battery system 10 preferably have a standardized construction. In addition, a battery module 16 is preferably provided with a cooling plate 20 through which a coolant can be conducted in order to control the temperature of the storage cells 18 and therefore heat can be preferably drawn from or else supplied to the storage cells 18.

According to the invention, the battery modules 16 of the battery system 10 comprise at least one prismatic storage cell 18. In FIG. 1, a battery pack 14 is formed from a plurality of battery modules 16, wherein each battery module 16 is formed, in each case purely by way of example and in a non-limiting manner, from six storage cells 18 which are connected to one another. According to the invention, a battery module 16 can also comprise more or less than six storage cells 18 in this case. The number of storage cells 18 depends on the required power and energy parameters of the battery module 16 and the power and energy parameters of the individual storage cells 18. The number of battery modules 16 also depends on the required power and energy parameters of the battery pack 14 and the power and energy parameters of the individual battery modules 16. The number of battery packs 14 accordingly depends on the required power and energy parameters of the entire battery system 10.

The docking station 12 has a docking region 22 in which the battery modules 16 are arranged. In said docking region 22, a docking location 42 with supply and power connections is provided for each battery module 16. In this case, at least one degassing connection 24 for diverting away outgassings from the connected battery module 16, a control connection for controlling and monitoring the connected battery modules 16, power connections 28 for drawing away electrical energy from or introducing electrical energy into the connected battery module 16, and coolant connections 30 for supplying coolant to the connected battery modules 16 are preferably provided.

The docking station 12 has corresponding supply and power lines which issue into the respective connections. Therefore, electrical lines for electrically connecting the battery modules 16 to one another are preferably arranged in the docking station 12. In addition, the docking station preferably has coolant lines, degassing lines and control lines. As an alternative, the individual connected battery modules 16 can also be controlled and monitored by signal transmission by radio according to the invention. In this case, the docking station 12 is preferably operatively connected to a drive system of a motor vehicle.

The docking station 12 shown in FIG. 1 has twelve docking locations 42 for arranging twelve battery modules 16. The maximum number of battery modules 16 which can be arranged on the docking station 12 is therefore limited, by way of example, to twelve in this case. Seven of the twelve docking locations 42 are occupied in FIG. 1, by way of example. That is to say, a battery module 16 is connected to seven docking locations 42. When used, in particular, as a power battery in a motor vehicle, the battery system 10 according to the invention is preferably designed such that the required power and energy parameters of the battery system are achieved with a minimum number of battery modules 16. In this case, the minimum number is preferably smaller than the maximum number. According to the invention, the battery system can also comprise a plurality of docking stations 12.

The battery modules 16 which are connected to the docking station 12 are preferably connected to the docking station 12 by means of a plug connection, latching devices, a click-connection apparatus, a clamping apparatus, a bracing apparatus or a rail system.

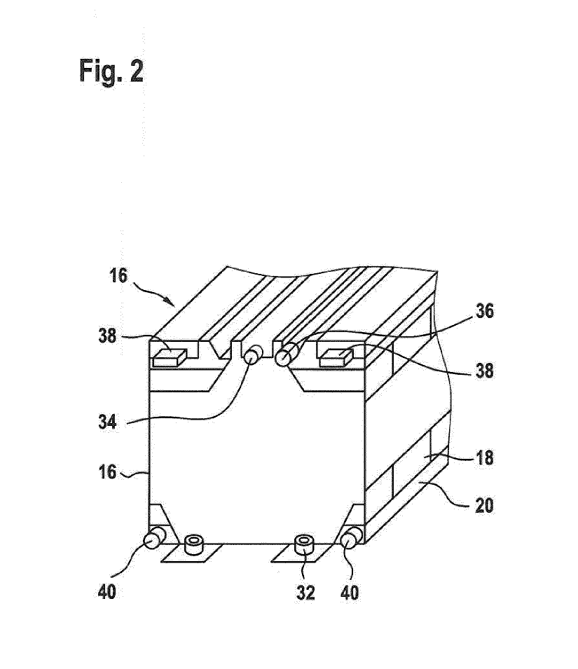

FIG. 2 shows, by way of example and in a non-limiting manner, a view of a detail of a battery module 16 of the above-described battery system 10 according to the invention. That side of the battery module 16 which faces the docking region 22 of the docking station 12 in the installed state is shown. According to the invention, said side can be a front, rear, top or bottom of the battery module 16.

The side which faces the docking region 22 of the docking station 12 has the pack-side connections 34 to 40 for the docking station-side connections 24 to 30 which are shown in FIG. 1. The pack connections 34 to 40 are designed so as to correspond to the connections 24 to 30 of the docking station 12 in respect of their shape and in respect of their position. Therefore, a battery pack 14 preferably has at least one module degassing connection 34 for diverting away outgassings, a module control connection 36 for controlling and monitoring purposes, module power connections 38 for drawing away or introducing electrical energy, and/or module coolant connections 40 for supplying coolant.

In addition, connecting elements 32 are preferably provided on the battery modules 16 in order to position and/or in order to mutually fix further battery modules 16.

The battery system 10 according to the invention is preferably implemented in a motor vehicle in all of its refinements. Said battery system is preferably implemented as a power battery in an electric or hybrid vehicle.

In this case, the battery system 10 is intended to store electrical energy, in particular which is generated externally from the motor vehicle, and provide this energy in order to operate the motor vehicle. The battery system 10 according to the invention is designed such that a charging process of the battery system according to the invention can take place outside the motor vehicle in a stationary state. During this charging process, the motor vehicle can be operated with other battery modules 16 which are already charged. In a method according to the invention, it is provided for this purpose that the battery modules 16 can be individually removed from the docking station 12 and inserted.

1. A battery system comprising:
at least one battery module including at least one storage cell; and
a docking station on which the at least one battery module is arranged such that the at least one battery module is configured to be removed separately.

2. The battery system as claimed in claim 1, wherein:
the docking station includes electrical conductors, and
battery modules of the at least one battery module, which are arranged on the docking station, are electrically connected to one another by the docking station.

3. The battery system as claimed in claim 1, wherein battery modules of the at least one battery module have identical constructions.

4. The battery system as claimed in claim 1, wherein:
the docking station has at least two docking locations and each battery module of the at least one battery module is configured to be arranged at a respective docking location of the at least two docking locations,
the at least two docking locations include at least one of supply connections and power connections, and
the at least one of the supply connections and the power connections are configured to be operatively connected to at least one of module-end supply connections and module power connections of the battery modules.

5. The battery system as claimed in claim 4, wherein:
each battery module includes a cooling plate and module coolant connections as supply connections, and
the at least two docking locations of the docking station each have matching coolant connections for said module coolant connections.

6. The battery system as claimed in claim 4, wherein:
each battery module includes at least one module degassing connection as the supply connection, and
the at least two docking locations of the docking station each have at least one matching degassing connection for said module degassing connection.

7. The battery system as claimed in claim 4, wherein:
each battery module includes at least one module control connection as the supply connection, and
the at least two docking locations of the docking station each have at least one matching control connection for said module control connection.

8. The battery system as claimed in claim 1, wherein each battery module of the at least one battery module includes connecting elements for arranging further battery modules.

9. The battery system as claimed in claim 1, wherein the docking station includes a fixing mechanism configured for reversibly fixing the battery modules.

10. A motor vehicle comprising:
a drive system; and
a battery system including (i) at least one battery module having at least one storage cell and (ii) a docking station on which the at least one battery module is arranged such that the at least one battery module is configured to be removed separately,
wherein the docking station of the battery system is connected to the drive system of the motor vehicle.

11. The motor vehicle as claimed in claim 10, wherein:
the motor vehicle is configured to be operated with a minimum number of battery modules, and
the minimum number is smaller than a maximum number of battery modules which the docking station is configured to accommodate.

12. A method for producing a ready status for a motor vehicle comprising a battery system including (i) at least one battery module having at least one storage cell and (ii) a docking station on which the at least one battery module is arranged such that the at least one battery module is configured to be removed separately, the method comprising:
individually removing discharged or defective battery modules from the docking station; and
replacing said individually removed discharged or defective battery modules.
